(19) United States
(12) Patent Application Publication
(10) Pub. No.: US 2012/0200852 A1
(43) Pub. Date: Aug. 9, 2012

(54) SPECTROSCOPY AND SPECTRAL IMAGING METHODS AND APPARATUS

(75) Inventors: Francisco Tejada, Baltimore, MD (US); Peter Griffin, Woodside, CA (US); Ricky James Morgan, Chestnut Hill, MA (US); Ali Abtahi, Canyon Country, CA (US); Usha Raghuram, Saratoga, CA (US); Frida Stromqvist Vetelino, Orlando, FL (US); Roderick Pearson, El Paso, TX (US)

(73) Assignee: AEROSPACE MISSIONS CORPORATION, El Paso, TX (US)

(21) Appl. No.: 13/229,185

(22) Filed: Sep. 9, 2011

Related U.S. Application Data
(63) Continuation-in-part of application No. 13/155,697, filed on Jun. 8, 2011.
(60) Provisional application No. 61/381,595, filed on Sep. 10, 2010.
(60) Provisional application No. 61/390,782, filed on Oct. 7, 2010.
(60) Provisional application No. 61/493,066, filed on Jun. 3, 2011.

(51) Int. Cl. G01J 3/28; H01B 13/00; B32B 38/00; B32B 37/00; B44C 1/22

(52) U.S. Cl. 356/326; 156/293; 216/24; 156/280; 156/292; 216/20

(57) ABSTRACT

The invention pertains to a new type of spectroscope comprising an array of Fabry-Perot cells having no moving parts and that can be fabricated inexpensively using semiconductor fabrication techniques.

### RELATED APPLICATION

This application is a non-provisional of U.S. provisional patent application No. 61/381,595 filed Sep. 10, 2010, U.S. provisional patent application No. 61/390,782 filed Oct. 7, 2010, and U.S. provisional patent application No. 61/493,066 filed Jun. 3, 2011, and is a continuation-in-part of U.S. patent application Ser. No. 13/155,697 filed Jun. 8, 2011, all of which are incorporated herein fully by reference and to which the present application claims priority.

### FIELD OF THE INVENTION

The invention pertains to the fields of spectroscopy, spectral imaging, and optical filters.

### BACKGROUND

Spectroscopy is the science of determining information about the spectral content of an electromagnetic radiation source. Thus, in its broadest sense, the science of spectroscopy encompasses basic photography cameras since a photograph contains spectral information about the observed scene, namely, the colors of light emanating from the observed scene. Hereinafter, we will sometimes use the term “light” as shorthand to refer to electromagnetic radiation of any wavelength. However, this is not intended to limit the discussion to electromagnetic radiation that is in the visible spectrum.

A spectroscope observes light from a source and determines spectral information about that light. The light source may be virtually anything, including, an object that produces its own light (such as a star, a laser, or the molecules involved in a phosphorescent chemical reaction), light that is reflected off an object, and light that passes through an object. Spectral information about an original source of light can provide information about the chemical composition of the source of the light. Likewise, if one knows the spectral composition of the original light source, light reflected from or light transmitted through an object can provide information about the chemical composition of the object. For instance, the portion of the light spectrum that can and cannot pass through an object could disclose the chemical composition of the object. The same is true for light reflected from an object.

Spectroscopes with extremely high spectral resolution are useful in many applications including scientific and military applications. For instance, spy planes may carry cameras capable of capturing images containing very broad spectral information and very high spectral resolution in order to detect the existence of certain materials, to see through things that are opaque to the visible eye, and/or to provide highly detailed spectroscopic images.

One form of spectroscopy, known as standing wave spectroscopy, takes advantage of the constructive interference that occurs when a beam of light of a particular wavelength is reflected back on itself so that two beams of the same light interfere with each other. FIG. 1A is a diagram illustrating the basic structure of a standing wave spectroscope 100. It should be understood that, while FIG. 1A (as well as other figures in this specification, such as FIGS. 2A, 2B, and 3) shows the light beam 101 as a line and shows each segment 101-1, 101-2 displaced vertically from the preceding segment, in actuality, the beam and each segment thereof has an actual width and that the beam segments are not vertically displaced from each other as illustrated, but rather at least partially physically overlapping. They are shown as lines and vertically offset from each other so that they do not overlap in the drawings in order to allow the various beam segments being discussed to be visually differentiated from each other for purposes of illustration and discussion.

In FIG. 1A, a continuous light beam 101 (or at least of sufficient duration to exist within the system for many reflections) propagating in a first direction reflects off reflective surface 106, with no phase change on reflection, so that it interferes with itself in the space 102. A detector 108 detects the interfering light in space 102 without significantly disturbing the beam. Light having a wavelength equal to twice the distance, d, between the reflector 106 and the detector 108 (and harmonics thereof) will interfere constructively and produce a relatively high amplitude signal that is detected by the detector 108. Light at other frequencies will interfere destructively and have lower amplitude, with the amplitude decreasing as the distance d becomes increasingly different from ½ the wavelength of the light. FIG. 1B illustrates intensity of the detected light at detector 108 for a monochromatic light beam as a function of the distance, d, between the reflector 106 and the detector 108, assuming the reflectivity of the detector is relatively high. As can be seen in FIG. 1B, the detected intensity is greatest at ½ the wavelength, θ, of the light, tapers off on either side of θ/2, and is periodic, such that there are multiple peaks at different distances, d. One property indicative of the sensitivity of a spectroscope to wavelength is known as the full wave half maximum (FWHM) value. The FWHM is the wavelength range surrounding wavelength θ for which the signal amplitude is equal to or greater than half the maximum signal amplitude M.

Thus, by measuring the intensity of the light detected at the detector and scanning the distance, d, between the reflector 106 and the detector 108, one can determine the spectral content of a light beam.

FIG. 2A illustrates another spectroscopy technique utilizing what is known as a Fabry-Perot cell 200. In a Fabry-Perot cell, a light beam 201 enters a space or cavity 203 between two reflectors 204, 205 with a detector 208 positioned outside of the cavity behind one or both of the reflectors. As in a standing wave spectrometer such as described above, the various reflected segments 201-1 through 201-6 of continuous light beam 201 will interfere with themselves in the cavity, thus producing total constructive interference in the rightward direction and total destructive interference in the leftward direction with respect to any light having a wavelength equal to 2I. As is well known, when the distance, I, between the two reflectors is very small, on the order of about one wavelength or less of the light in the cavity, the reflectivities or transmissivities of the reflectors 204, 205 do not behave individually according to classical geometric optics, but rather will depend upon the distance, I, between the two reflectors. For instance, when I is ½ the wavelength of the beam in the cavity, such that the beam segments 201-1, 201-3, and 201-5 that are propagating in the rightward direction in cavity 203 are in phase with each other and interfere entirely constructively, then cell 200 will behave completely transparently to beam 201. On the other hand, when light beam segments 201-2, 201-4, and 201-6 interfere constructively for I equal to one quarter the wavelength of the light beam 201, the exact opposite would be true, i.e., all the light would be reflected in cell 200.

Thus, a detector 208 placed behind one of the reflectors 204 or 205 would detect light of an intensity that would vary as a function of the ratio of Ito the wavelength content of the light in the cavity 203. Thus, by varying I, a Fabry-Perot cell can be used to determine the wavelength content of a light beam. Light at other wavelengths essentially will interfere partially destructively or constructively. Again, by varying the distance between the two reflectors, the cell can be used to determine the wavelength content of light in the cavity. A detector could be placed behind each reflector to increase the sensitivity of measurement. However, in theory, both detectors should detect essentially complementary signals, thus revealing identical information. If I is fixed, this system essentially is an optical filter.

In theory, all light in a perfect Fabry-Perot cell will be transmitted through one of reflectors 204 and 205 (i.e., the amount of light entering the cell is equal to the amount of light exiting the cell per unit time), with the percentage of the light that is transmitted through each reflector 204, 205 depending on the distance between the two reflectors. For example, if I is ½ the wavelength of monochromatic light in the cell, then 100% of the light in the cell will be transmitted through reflector 204. If I is ¼ the wavelength of monochromatic light in the cell, then 100% of the light in the cell will be transmitted through reflector 205. At other distances, some percentage of the light may be transmitted through reflector 204 and the rest is transmitted through reflector 205.

However, no Fabry-Perot cell is perfect. In actuality, some light always is reflected and some always is transmitted. The Q of a Fabry-Perot cell is a measure of the quality of the cell. More specifically, the Q of a cell is the number of times that a light beam will bounce back and forth in the cell before the amount of light entering the cell is equal to the amount of light exiting the cell per unit time. The higher the Q in a Fabry-Perot cell, the narrower the FWHM. This, in turn, means that the cell is more sensitive to wavelength and produces a more robust output measurement.

FIG. 2B is a diagram of a modified Fabry-Perot cell 210 in which the cavity 213 between the two mirrors 214, 215 is not a vacuum or air-filled, but is instead filled with a light absorbing material 216, which, for instance, may be a gas or a solid. The light absorbing material 216 can be more absorbent of certain wavelengths and less absorbent of others. In this manner, one can create a cavity that is extremely sensitive to a particular wavelength of light, i.e., it has a very narrow full width half maximum (FWHM) value.

One common problem with the manufacture of Fabry-Perot cells is the placement of the circuitry needed to move one of the reflectors (in order to vary I over time) and the circuitry of the detector. Generally, one of the reflectors must have circuitry directly behind it in order to make the reflector translatable so as to vary the gap of the cavity. The detector therefore must be placed behind the other reflector because the light passing through the movable reflector cannot make it through the movement circuitry to be detected by a detector positioned behind that reflector. With the detector circuitry on one side of the cavity and the movement circuitry behind the other side of the cavity, it is difficult to provide an open pathway for light to initially enter the cavity.

### SUMMARY OF INVENTION

According to one aspect, the invention pertains to a new type of spectroscope comprising an array of Fabry-Perot cells having no moving parts and that can be fabricated inexpensively using semiconductor fabrication techniques. In other embodiments, one of the reflectors may be movable to provide even greater flexibility in the system.

### BRIEF DESCRIPTION OF THE DRAWINGS

FIG. 1A is a diagram illustrating a standing wave spectroscope of the prior art.

FIG. 1B is a graph illustrating a spectral distribution measurement in a standing wave spectroscopic cell.

FIG. 2A is a diagram illustrating a Fabry-Perot cell of the prior art.

FIG. 2B is a diagram illustrating another type of Fabry-Perot cell of the prior art.

FIG. 3 is a cross-sectional side view of a focal plane array in accordance with the principles of the present invention.

FIGS. 4A-4G are diagrams illustrating various stages in one semiconductor fabrication process for manufacturing the focal plane array of the spectroscopic imaging device illustrated in FIG. 3.

FIG. 5 is a cross-sectional side view of a spectroscopic imaging device in accordance with the principles of the embodiment of FIGS. 3 and 4A-4G illustrating operation of the device.

FIG. 6 is a plan view of a focal plane array of a spectroscopic imaging device in accordance with one particular embodiment.

FIGS. 7A through 7E illustrate stages of another fabrication technique for producing a spectroscope in accordance with the principles of the present invention.

FIGS. 8A through 8E illustrate stages of yet another fabrication technique for producing a spectroscope in accordance with the principles of the present invention.

FIGS. 9A and 9B illustrate stages of two more fabrication techniques for producing a spectroscope in accordance with the principles of the present invention.

FIGS. 10A and 10B illustrate stages of yet two further fabrication techniques for producing a spectroscope in accordance with the principles of the present invention.

FIGS. 11A and 11B illustrate stages of two additional fabrication techniques for producing a spectroscope in accordance with the principles of the present invention.

FIGS. 12A and 12B illustrate stages of yet two more fabrication techniques for producing a spectroscope in accordance with the principles of the present invention.

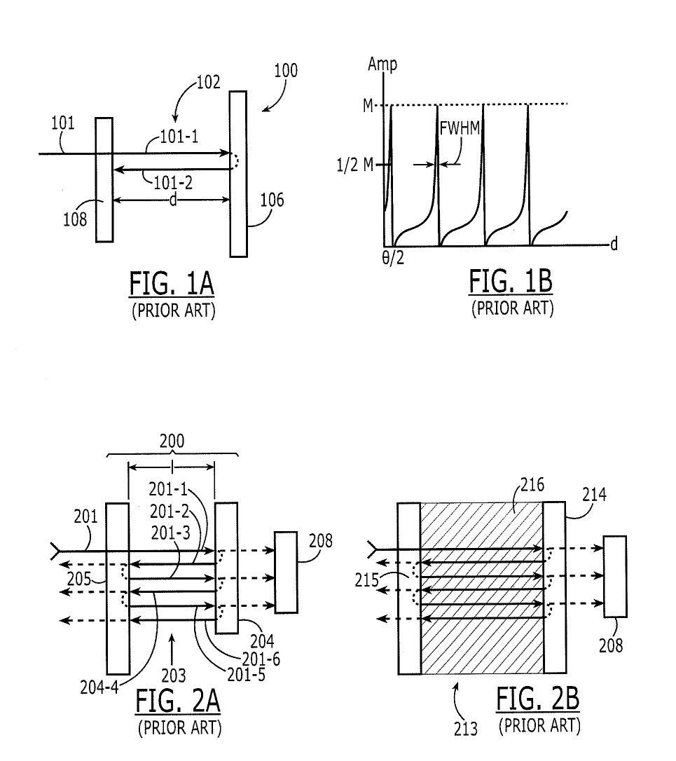

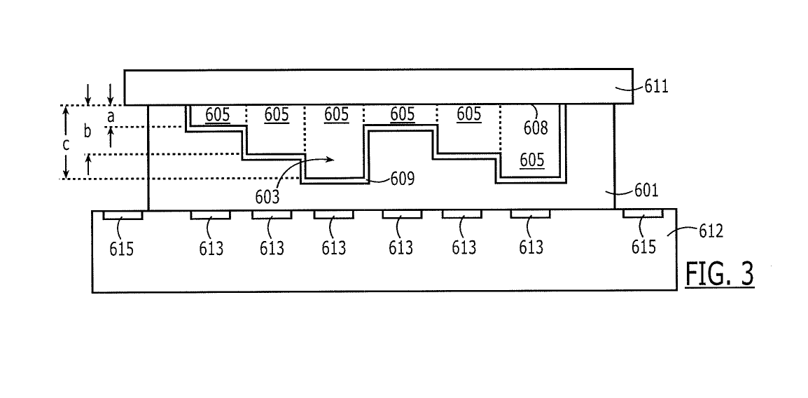

### DETAILED DESCRIPTION OF THE EMBODIMENTS

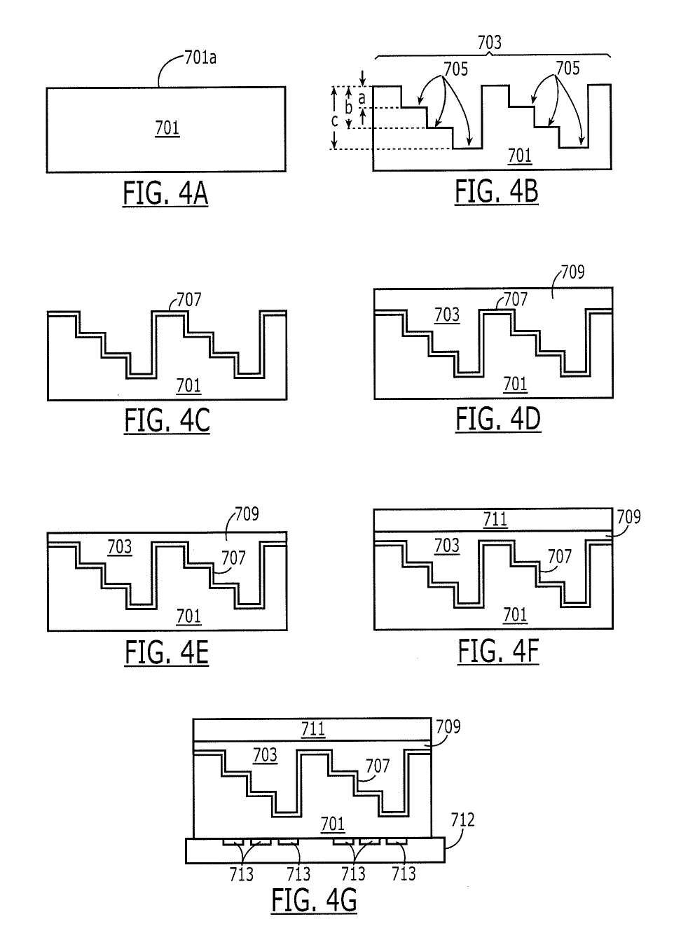

FIG. 3 is a cross-sectional side view of a focal plane array 600 of spectroscopic cells in accordance with the principles of the present invention. A transparent substrate 601, such as silicon, sapphire, glass, quartz, etc., is selectively etched to form a stepped volume 603 comprising a series of segments having different depths below the top surface 608 of the substrate 601, each of which will form a separate spectroscopic cell 605 for detecting light of a different wavelength. A first reflector 609 is disposed on at least the bottom surfaces within the volume 603 (i.e., the upwardly-facing horizontal surfaces in FIG. 3). A second, planar reflector 611 coplanar with aforementioned surface 608 is disposed on top of the volume, thus forming a plurality of Fabry-Perot cells 605 of different depths in the volume 603. An integrated circuit chip 612 bearing a plurality of detectors 613 and any other desired circuitry 615, such as measurement and signal conditioning circuitry, are disposed on the bottom of the transparent substrate 601, each detector 613 is located below one of the cells 605 in order to detect the light that bounces around in that cell. The integrated circuit 612 can be formed using a conventional silicon or other opaque substrate since the light to be measured can enter the volume through semi-transparent top reflector 611.

The cells 605 can be fabricated to match the layout and lateral dimensions of an existing detector array. In another embodiment, the detector and other circuitry 613, 615 may be fabricated directly in substrate 601, since substrate 601 may be thick.

In this structure, the cavity depths are not adjustable, but are limited to the selected etched cavity step depths. FIG. 3, for instance, shows a volume comprised of a repeating pattern of spectroscopic cells 605 of three different depths a, b and c. The number of step sizes and their arrangement will depend on the particular application. For instance, in applications where there is interest only in detecting one or a limited number of wavelengths, an embodiment such as in FIG. 3 with only three (or even fewer) cavity depths may be perfectly acceptable. Potential applications for such spectroscopes may include explosives detectors in airports and other security situations, in which it is desired to detect the spectral signature of only one or a small number of materials, and thus it is necessary to detect only at a small number of wavelengths.

Merely as an example, if it is desirable to detect light at eight specific wavelengths, then the substrate may be selectively etched to provide eight different step depths. In one embodiment, all eight different step depths can be positioned adjacent to one another. If desired, the optics for directing the light into the volume 603 can be designed so that the eight adjacent cells look at light coming from the same point (or at least very close points) to create one super-pixel capable of detecting light of eight different wavelengths. A plurality of such super-pixels may be disposed in an array to produce a multi-pixel spectral image, each super-pixel detecting the presence or absence of light of eight different specific wavelengths. The spatial resolution of the image may be the size of one eight-cell super-pixel in the absence of light-directing optics. If no imaging resolution is desired, then one may fabricate a spectroscope in which every cell is of a different depth in order to maximize wavelength resolution.

The cells may be of any shape, the rectangular cells illustrated in the drawings merely being exemplary. Further, the cell may be arranged in any layout, the column and row arrangement illustrated in the figures merely being one example. Different parts of the same array may have differently shaped pixels and/or different pixel layouts. The pixel shapes, sizes (resolution), and layouts should be selected and adapted to the specific application.

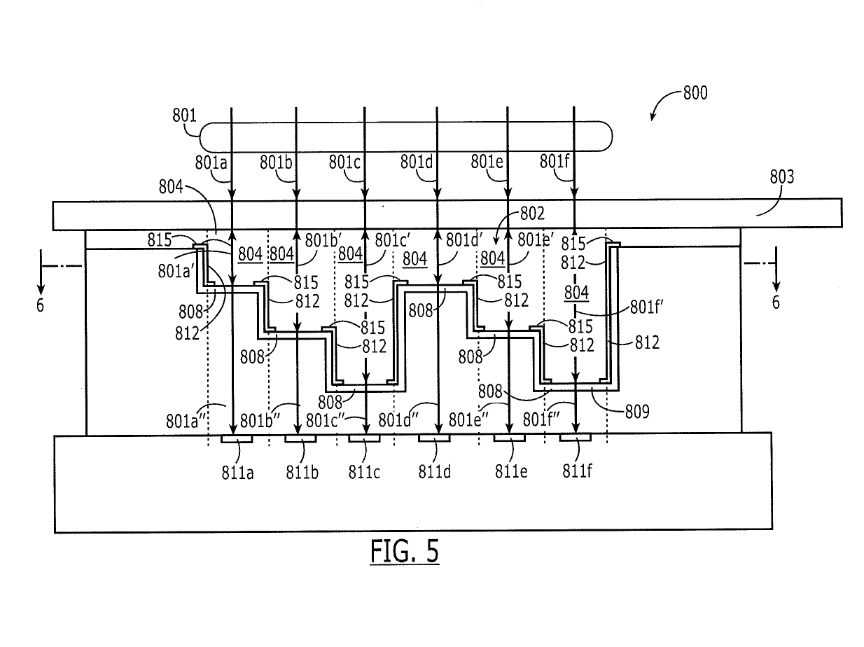

In accordance with one embodiment, a focal plane array can be fabricated in accordance with this embodiment as illustrated in FIGS. 4A through 4G. Referring first to FIG. 4A, the starting material is a transparent substrate 701. Through selective etching, top surface 701a of the substrate 701 can be etched to form a plurality of cavities 705 of different depths. The lateral size, shape, and layout of the steps are not constrained. For example, the cells may be squares, rectangles, triangles, hexagons, circles, etc. The depths may be arranged in any pattern and number.

FIG. 4B shows an etched volume 703 comprising six steps 705 of three different depths, namely, a, b, and c. Each set of three adjacent cells of different depth can be used as a super-pixel, for instance.

Next, with reference to FIG. 4C, a reflective coating 707, such as silver, or a distributed Bragg reflector, can be deposited or otherwise placed in the volume using any of a number of conventional semiconductor fabrication techniques, including, but not limited to, chemical vapor deposition (CVD) and plasma enhanced chemical vapor deposition (PECVD) techniques.

Next, a second reflector may be placed directly on top of the assembly to create the cells, the cells being occupied by air or another gas. The reflector may be semi-transparent so that the input light can be introduced into the volume 703 from the top through the reflector. The second reflector may be formed in any number of ways. For instance, a reflective material may be deposited on another substrate and then bonded to the top side of the substrate 701.

However, simply allowing the volume 703 to be occupied by air may have drawbacks. Specifically, even in a semiconductor fabrication cleanroom, there is generally dust and other particles in the air, many of which may be larger than the desired gap depth. Accordingly, a single speck of dust trapped in the volume could render one or more pixel cells inoperative. Thus, it might be difficult or impossible to reliably fabricate a focal plane array with small cavity depths with only air or another gas in the gap. In addition, to control the gap depths across the entire array, the reflectors 707 at the bottoms of each cell need to remain parallel to the reflector 711 that will be placed on top (FIG. 4F). It is difficult to maintain alignment when installing reflector 711 even in a vacuum. Finally, when dealing with such small gaps, the surface tension and viscosity of the gas becomes important and additional fabrication procedures may be necessary in order for the gas to be exhausted from the gap.

In order to address these concerns, one may fill the volume 703 with a transparent material after the reflective coating 707 has been deposited and before the second reflector 711 is attached. Thus, in accordance with one embodiment, a transparent resist 709 may be applied to fill the volume 703 as shown in FIG. 4D. Filling of the cavity 703 with resist 709, e.g., spin-on resist, is one well-known semiconductor fabrication technique that may be used to fill the cavity and will not be described in detail.

Note that, if the resist material 709 has a different index of refraction than air or vacuum, this must be taken into account in selecting the cavity depths.

Note however that, if silver is used as bottom reflector 707, then the transparent spin-on material 709 should be a polymer rather than a glass so that it can be cured at relatively low temperatures (e.g., below 250° C.). Particularly, spin-on glass typically is cured at temperatures higher than 250° C. However, above approximately 250° C., the silver would likely diffuse into the spin-on resist 709. On the other hand, if Bragg reflectors were used for the bottom reflectors, then it would be possible to employ higher cure temperatures on the spin-on resist, which might allow the use of a spin on glass as the fill material 709.

With reference to FIG. 4E, the spin-on resist layer 709 is polished, such as by Chemical Mechanical Polishing (CMP), which is a well-known planarization process in the semiconductor fabrication arts.

Next, with reference to FIG. 4F, a second reflector 711 is placed on the planarized, transparent spin-on layer 709. In one embodiment, reflector 711 is semi-transparent so that the input light can be introduced into the volume 703 from the top, through reflector 711. The second reflector 711 may be formed in any number of ways. For instance, a layer of semi-transparent reflective material may be deposited by CVD or PECVD. In another embodiment, a reflective material may be deposited on another substrate and then bonded to the top side of the substrate 701. The second reflector 711 and any substrate it may be mounted on may be semi-transparent so that light may be introduced into the volume through it.

Next, with reference to FIG. 4G, detector hardware, such as an integrated circuit die 712, bearing a plurality of separate detectors 713, each one directly below one of the cells 705 can be bonded to the bottom of the transparent substrate 701, or can be fabricated on the substrate, thus completing the process of forming an array of spectroscopic cells of different depths. Additional circuitry, such as detector electronics, also may be fabricated on substrate 712 or on the bottom of substrate 701.

In other embodiments, the array of cells may be sized and shaped so that it can be retrofitted to an existing array of detectors. For instance, the array may be designed to match and be retro-fitted to a detector array of an existing panchromatic (black and white) camera to provide a color image. Even further, in certain embodiments, there may be no detectors at all. For example, the planar array of FIG. 4F may be used as a microscope slide. Particularly, a sample to be observed may simply be placed upon the cell array and the cell array placed under a microscope. White light may be shone through the array and sample from the bottom and the eye of the person looking through the lens of the microscope is the “detector”.

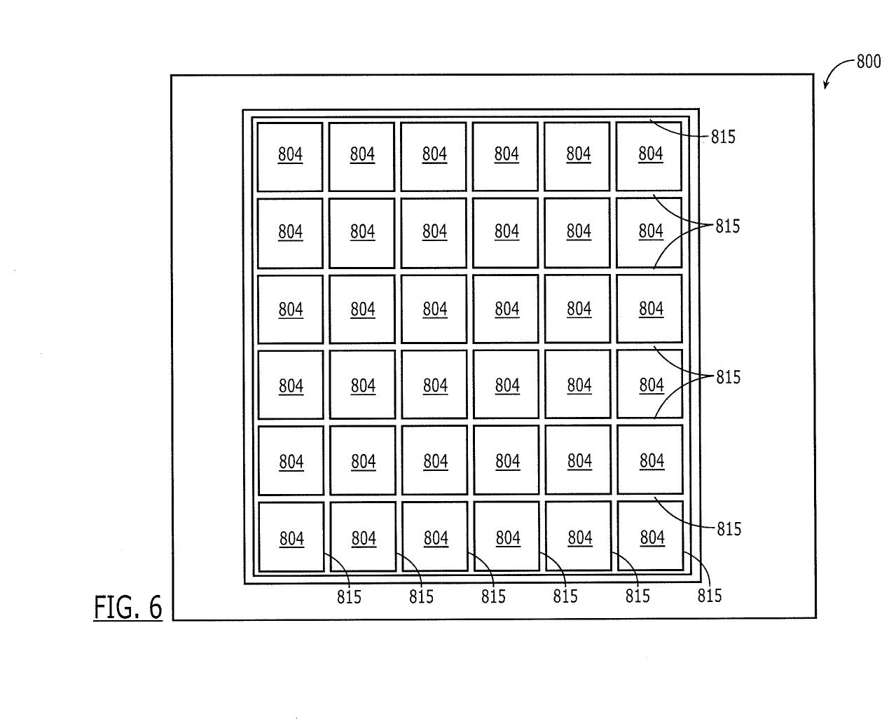

FIG. 5 illustrates operation of a device in accordance with the embodiments of FIGS. 3 and 4A-4G. Particularly, collimated light beam 801 is introduced into the volume 802 through top reflector 803 directed substantially perpendicular to the horizontal surfaces 808 of the cells 804. Accordingly, distinct portions 801a-801f of the total input light 801 will reflect back and forth in each individual cell 804 as illustrated by beam segments 801a′-801f′ in FIG. 5. Optics (not shown) may be necessary to precisely align the incoming light. For each roundtrip pass through the respective cell 804, a portion of the light passes through the bottom reflector 809 and transparent substrate 810 and reaches the corresponding detector 811a-811f, as illustrated by beam segments 801a″-801f″.

The dashed lines in FIG. 5 that are generally coplanar with the vertical walls 812 in the volume are for reference purposes to help visually identify the boundaries between the discrete cells 804, but do not necessarily represent any actual physical element. These dashed lines essentially define the transition from one cell to the next. In theory, vertical walls 812 are perfectly vertical. Furthermore, the light beams in the volume also are vertical. However, in actual practice, the vertical walls may not be perfectly vertical and/or the light beam may not be perfectly collimated or vertical. Furthermore, the reflectors are not perfect, and, therefore, some of the light may scatter in different directions in the volume. This could lead to light passing through the vertical walls 812 and reaching the detectors 811a-811f. This would introduce error into the measurements because the light reaching the detectors through the vertical walls 812 would be of essentially unknown wavelength because it has not undergone the expected constructive/destructive interference process that is at the core of the theory of operation of a Fabry-Perot cell. Accordingly, it may be advisable to add a fabrication step before or after the formation of the bottom reflector 809 (and before the formation of the transparent fill material) that places a pattern of strips of highly light-absorbent material to cover the areas surrounding the vertical walls in the volume.

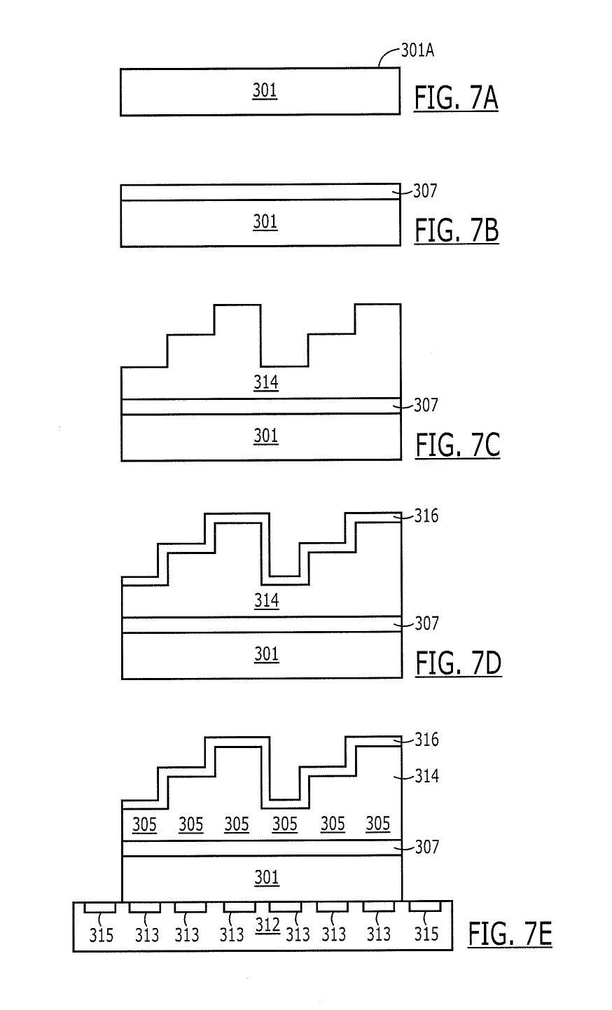

This concept is best understood in relation to FIG. 6, which is a top plan view of the focal plane array of FIG. 5 taken through section 6-6. However, the structure is best seen in FIG. 5. In particular, photoresist is deposited, exposed through a mask corresponding to the desired pattern of strips, and etched to form the desired photoresist pattern of strips surrounding the vertical walls 812. Then, a black or otherwise light-absorbent material, such as aluminum or carbon, is deposited over the photoresist to form strips 815 over the vertical walls 812 in the volume. Finally, the photoresist is removed, leaving light-absorbent strips 815 as seen in FIGS. 5 and 6. Such a light-absorbent material will minimize or eliminate any light reaching the detectors through those vertical walls.

Alternately or additionally, horizontal strips of light absorbent material may be placed in or on the top reflector 803 at the perimeters of the cells. A top view of such an embodiment would look essentially the same as FIG. 6. Such horizontal strips may be placed by deposition and etching on either the top or bottom surface of reflector 803.

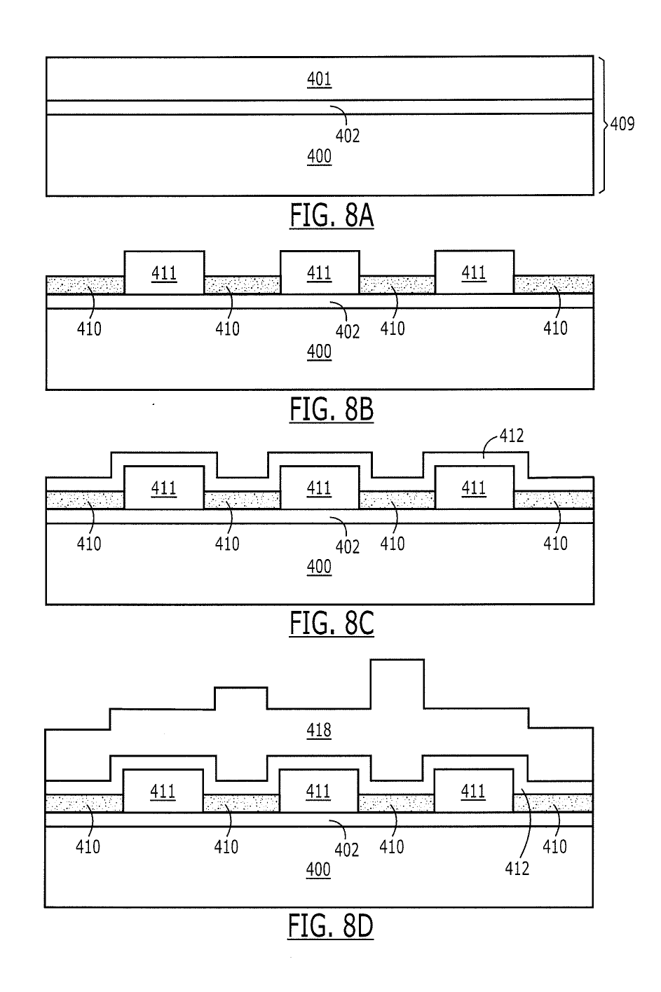

In accordance with yet another embodiment, a focal plane array can be fabricated in accordance with the technique illustrated in FIGS. 7A through 7E. This technique is somewhat similar to the technique of FIGS. 4A-4G, but a first reflector is deposited on the substrate first and the stepped cavities are built on top of the first reflector (as opposed to the reflectors being deposited on top of the steps after the steps have been etched in the substrate). Referring first to FIG. 7A, the starting material is a transparent substrate 301, just as in connection with the embodiment of FIGS. 4A-4G.

Next, with reference to FIG. 7B, a reflective coating 307, such as silver or a distributed Bragg reflector, is be deposited or otherwise placed on top of the substrate 301 via any of a number of conventional semiconductor fabrication techniques, including, but not limited to, chemical vapor deposition (CVD) and plasma enhanced chemical vapor deposition (PECVD) techniques. As before, although illustrated as a full reflective coating on top of the substrate 301, the reflector 307 need not cover the entire surface, but rather only the portions of the substrate that are going to form the bottoms of the reflecting cells. Also, since the substrate 301 is transparent, the reflector also could be placed on the bottom of the substrate 301 so that the substrate is within the cavity. However, this would likely require the substrate 301 to be made very thin since the gap inside of a Fabry-Perot cell typically is desired to be very small, such as on the order of less than a wavelength. Accordingly, the reflector 307 is placed on top of the substrate in the embodiment of FIG. 7B.

Next, with reference to FIG. 7C, the steps are fabricated of a transparent material. In accordance with one embodiment, a transparent layer 314, such as oxide, is deposited over the reflector 307. Again, the transparent layer need be over the portions of the transparent layer 314 that will correspond to the locations of the detectors. However, alternately and as illustrated, it may be more cost-effective to simply place transparent layer 314 over the entire wafer. The thickness of the oxide 314 may be made different in different locations by using different photolithography masks. For instance, continuing with an exemplary array having three different cell depths, three different masks can be used to create a different oxide thickness over every third detector 313. In one embodiment, three different thickness levels may be provided by using a first mask that allows deposition of oxide over all detectors (which encompasses no mask at all so that a first layer of oxide is deposited over the entire wafer), a second mask for depositing a second later of oxide over two of every three detectors, and a third mask for depositing a third layer of oxide over one of every two of the detectors having the second layer of oxide. However, in a more preferred embodiment, all of the oxide deposited over each detector is deposited in one continuous oxide deposition step using a single mask each. In other words, each mask exposes only one third of the detectors to oxide deposition, with each of the three oxide depositions processes being of different duration in order to provide different oxide depths for each of the three deposition processes/masks. This latter process is preferred because it avoids the creation of interfaces between the different layers of oxide built up upon each other that is inherent in the first method depth, which interfaces may reduce the quality and clarity of the oxide. Light absorbing strips between the cells, such as described above in connection with FIGS. 5 and 6, may be included at this stage also, if desired.

Turning to FIG. 7D, next, a second layer of reflector 316 is deposited over the oxide 314 to complete the formation of the gaps or cavities between the two reflectors 307 and 316, the various cavities having three different depths. In one embodiment, reflector 316 is semi-transparent so that the input light can be introduced into the gaps from the top, through reflector 316. The second reflector 316 may be formed in any number of ways. For instance, a layer of semi-transparent reflective material may be deposited by CVD or PECVD.

Next, with reference to FIG. 7E, detector hardware, such as an integrated circuit die 312, bearing a plurality of separate detectors 313, each one directly below one of the cells 305, and/or other measurement circuitry 315 can be bonded to the bottom of the transparent substrate 301, thus completing the process of forming an array of spectroscopic cells of different depths.

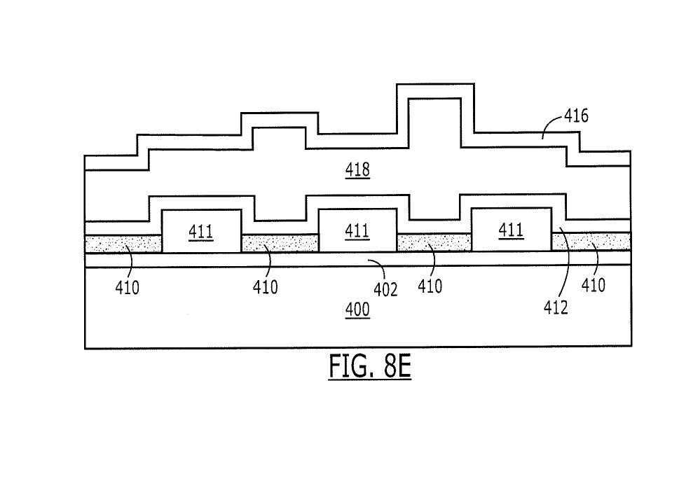

FIGS. 8A through 8E illustrate stages of another fabrication technique for producing a spectroscope in accordance with the principles of the present invention. This technique also utilizes semiconductor fabrication techniques, exemplified by the use of silicon on insulator (SOI) technology.

With reference to FIG. 8A, the starting point in this exemplary fabrication embodiment is a silicon on insulator (SOI) substrate 409 comprised of a thin silicon layer 401, an insulating layer 402 (e.g., a thin oxide layer), and a thick silicon layer 400. The SOI substrate 409 may be fabricated, for instance, using the Smartcut™ process developed by SOITEC of France.

Turning to FIG. 8B, the detectors 410, measurement-related circuitry 411, and any other semiconductor devices can be fabricated in the silicon layer 401 in accordance with conventional semiconductor fabrication processes.

Turning to FIG. 8C, next, a reflector 412 is then placed on top of the oxide/detector/circuitry 402, 410, 411. This can be done using any reasonable semiconductor fabrication technique, such as chemical vapor deposition. The reflector 412 only needs to be placed on top of the detectors 410, but can be placed over the entire wafer as well.

Next, referring to FIG. 8D, a stepped transparent layer 418, such as oxide, is deposited over the reflector 412. Again, the transparent layer need be over only the detectors 410. However, alternately and as illustrated, it may be more cost-effective to simply place transparent layer 418 over the entire wafer. The thickness of the oxide 418 deposited over different ones of the detectors 410 may be made different by using different photolithography masks. For instance, continuing with an exemplary array having three different cell depths, three different masks can be used to create a different oxide thickness over every third detector 410. In one embodiment, three different thickness levels may be provided by using a first mask that allows deposition of oxide over all detectors (which encompasses no mask at all so that a first layer of oxide is deposited over the entire wafer), a second mask for depositing a second later of oxide over two of every three detectors, and a third mask for depositing a third layer of oxide over one of every two of the detectors having the second layer of oxide. However, in a more preferred embodiment, all of the oxide deposited over each detector is deposited in one continuous oxide deposition step using a single mask each. In other words, each mask exposes only one third of the detectors to oxide deposition, with each of the three oxide depositions processes being of different duration in order to provide different oxide depths for each of the three deposition processes/masks. This latter process is preferred because it avoids the creation of interfaces between the different layers of oxide built up upon each other that is inherent in the first method depth, which interfaces may reduce the quality and clarity of the oxide.

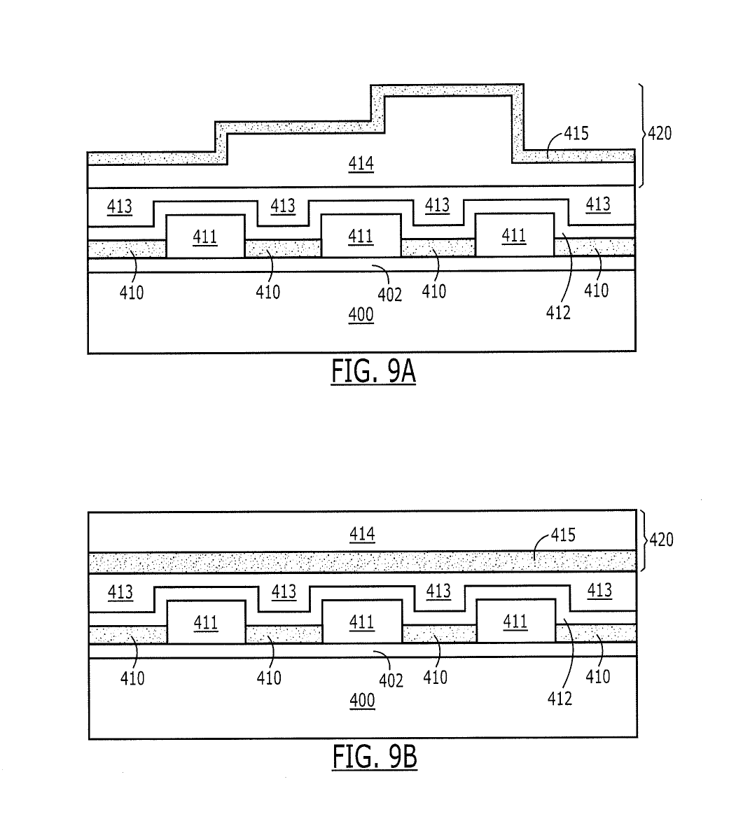

There also are several alternative ways to create an array of spectral cells starting with the structure of FIG. 8C, comprising the detectors (and other circuitry) disposed under the reflector layer 412. FIGS. 9A and 9B illustrate two alternate processes for completing the array. In both cases, first a layer of transparent bonding adhesive 413 may be deposited on top of reflector layer 412 and planarized for receiving a transparent substrate bearing a second reflector. Next, an assembly 420 comprising a transparent substrate 414, such as quartz, glass, or sapphire, supporting a reflector 415 is placed on top of the planarized adhesive 413. As shown alternately in FIGS. 9A and 9B, the reflector/transparent substrate assembly 420 may be placed with the reflective layer 415 either on the top (FIG. 9A) or the bottom (FIG. 9B). If the reflector 415 is placed on top of the substrate 414 (i.e., opposite the adhesive layer 413), as in FIG. 9A, the substrate 414 may be stepped, as shown, or planar. However, if the reflector is placed on the bottom of the substrate 414, as in FIG. 9B, it would be less practical to make the substrate 414 stepped (i.e., non-planar) because it would be more difficult to adhere the non-planar reflector to the assembly 430. In the first case of FIG. 9A, light may enter the cavities through the reflector 415 and the transparent substrate is within the cavities 414. In the second case of FIG. 9B, the transparent substrate is outside of the cavities and the light may enter the cavities through both the reflector 415 and the transparent substrate 414.

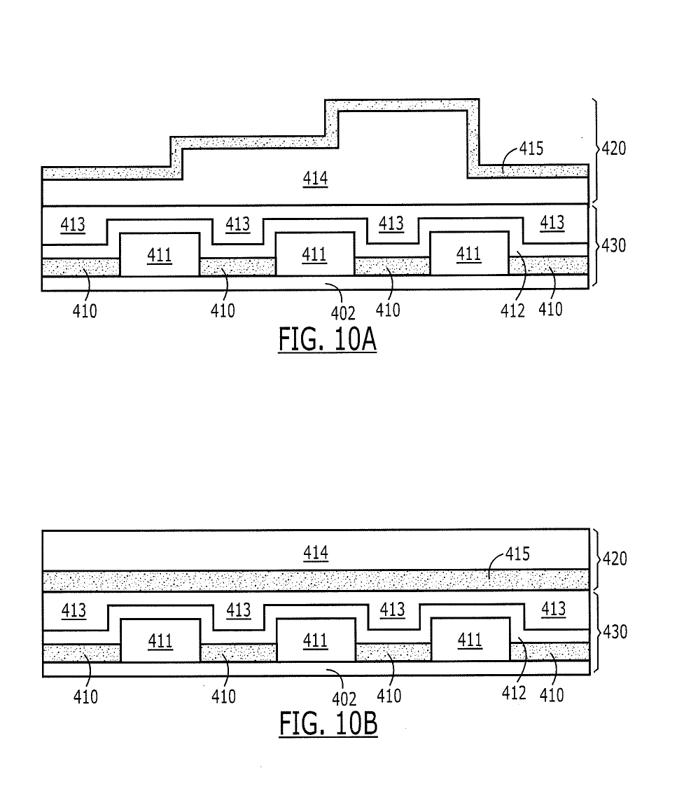

The arrays of FIGS. 9A and 9B also may be even further processed to produce yet other alternative embodiments wherein the light may enter the cavities through the first reflector 412. Specifically, FIG. 10A illustrates the further processing in connection with the embodiment of FIG. 9A and FIG. 10B illustrates essentially the same additional processing, but in connection with the embodiment of FIG. 9B. In both cases, once the substrate 414 is attached above the first reflector, there no longer is any need for thick silicon portion 400 of substrate to mechanically support the overall array because substrate 414 can now serve that purpose. Hence, silicon substrate portion 400 may be removed, such as by conventional semiconductor etching using the thin oxide layer 402 as an etch stop for the silicon etching. In these embodiments, light may now enter into the cavities through the thin oxide layer 402, the thin detectors 410, and first reflector 412, all of which are substantially transparent. Also, note that, since the light can enter the cavities through the bottom, substrate 414 for supporting the second reflector 415 need not even be a transparent substrate.

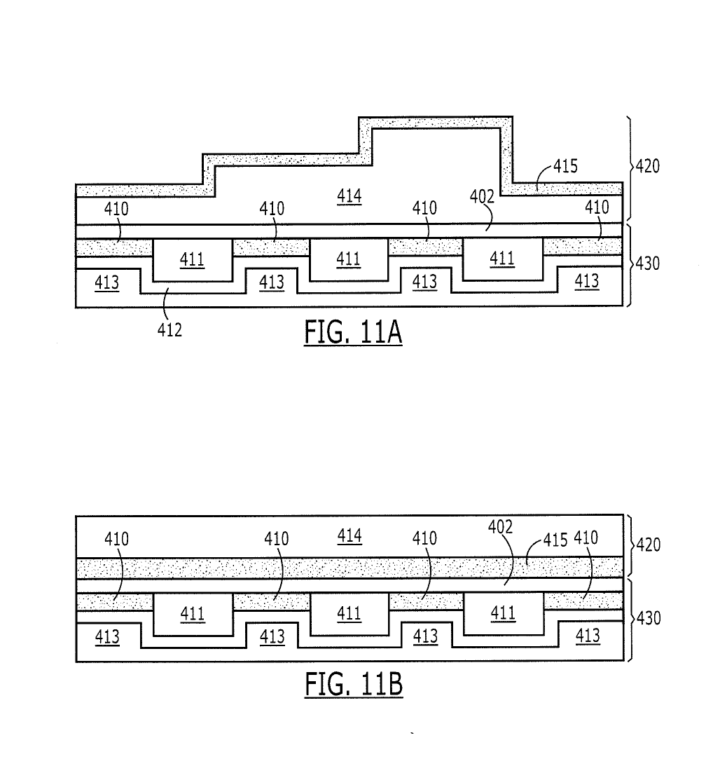

FIGS. 11A and 11B illustrate yet other embodiments in which the detectors actually are within the cavities, i.e., between the two reflectors 412 and 415. Specifically, the embodiments of FIGS. 11A and 11B are substantially identical to the embodiments of FIGS. 10A and 10B, respectively, except that the assembly 430 comprising the first reflector 412, circuitry, 410, 411, and insulator layer 402 has been flipped over before being attached to the top assembly 420. In these embodiments, the detectors 410 and other circuitry 411 are actually inside the cavities. In these embodiments, light may enter the cavities through either the top assembly 420 (assuming use of a transparent substrate 414) or through the bottom assembly 430. Specifically all the components of the bottom assembly 430, namely, the reflector 412, the detectors 410, and the thin insulator layer 402 are at least partially transparent. Thus, it may be disposed in either orientation. It may be useful or necessary to have the light enter the cavities through the bottom (and, thus, through the detectors), for instance, when the array is operated in reflection mode, i.e., the top reflector is perfectly or nearly perfectly reflective, or when it is operated as a wavelength selective light monitor.

In the embodiments of FIGS. 9B, 10B, and 11B, all of the cells are the same depth. These embodiments may be useful in applications requiring detection of very specific wavelengths.

These processes may be used to fabricate planar arrays of spectroscopic cells of any number of different cell depths in any arrangement inexpensively and quickly using semiconductor fabrication techniques. In addition, the spectral array disclosed herein further may be combined with existing movable reflector array technology. That is, alternately or additionally, the second reflector may be mounted on a movable base, such as a microelectromechanical system (MEMS), so that the gap depths of the pixels can be changed to provide greater flexibility.

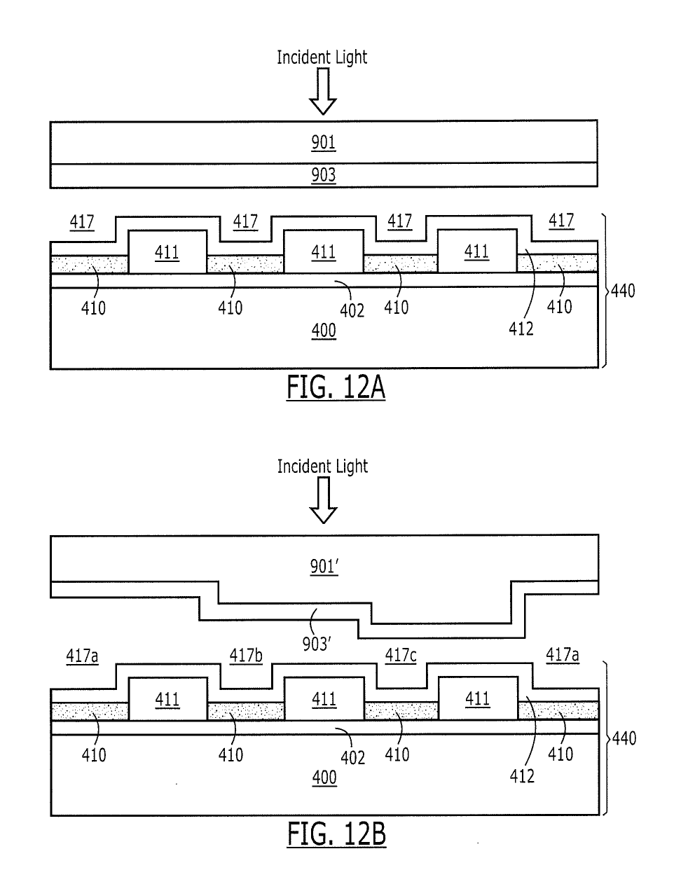

FIGS. 12A and 12B illustrate examples of two such embodiments. FIG. 12A illustrates the assembly 440 of FIG. 8C, but, instead of depositing a stepped transparent layer 414 over the reflector 412 and then a second reflector layer 416 over that (as in FIGS. 8D and 8E), a movable substrate 901 bearing a mirror 903 is positioned opposite the assembly 440. Accordingly, the cavities 417 can be varied in depth.

The embodiment of FIG. 12B is very similar to the embodiment of FIG. 12A, except that is shows that the substrate 901′ may be stepped so that the second reflector 903′ also is stepped. In this manner, the spectroscopic array has the advantages of both cavity depth adjustability and cavities 417a, 417b, 417c of different depths simultaneously.

Having thus described a few particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. An array of spectroscopic cells comprising:
a first substrate comprising a plurality of stepped segments of different depths;
at least one first reflector disposed on the first substrate to form a plurality of parallel, non-coplanar first reflecting surfaces;
at least one second reflector having a second reflecting surface disposed parallel and opposed to the at least one first reflector so as to collectively form with the at least one first reflector a plurality of reflecting cells of different gap distances between the first and second reflecting surfaces.

2. The array of spectroscopic cells of claim 1 wherein the stepped segments are defined by a stepped cavity in the first substrate.

3. The array of spectroscopic cells of claim 1 wherein the stepped segments are defined by a plurality of segments of different thicknesses on the first substrate.

4. The array of spectroscopic cells of claim 2 wherein the first substrate is a transparent substrate including a cavity in a first surface thereof, the cavity comprising a plurality of stepped segments of different depths below the first surface and wherein the at least one first reflector is disposed within the stepped segments and the at least one second reflector is disposed over the first surface of the transparent substrate.

5. The array of spectroscopic cells of claim 1 further comprising a plurality of electromagnetic radiation detectors.

6. The array of spectroscopic cells of claim 5 wherein the plurality of detectors comprises a detector located below each stepped segment.

7. The array of spectroscopic cells of claim 5 wherein the plurality of detectors are on an integrated circuit attached to the first substrate.

8. The array of spectroscopic cells of claim 4 further comprising;
a substantially transparent solid material filling the cavity.

9. The array of spectroscopic cells of claim 8 wherein the substantially transparent solid material is a spin on material.

10. The array of claim 1 wherein the at least one first reflector comprises a layer of reflective material disposed on the first substrate and the layer of reflective material is stepped.

11. The array of spectroscopic cells of claim 4 wherein each of the cells is separated from one or more adjacent cells by one or more substantially vertical walls and further comprising a light absorbent material covering the vertical walls.

12. A method of fabricating an array of spectroscopic cells comprising:
in a transparent substrate having a first outer surface, forming a cavity comprising a plurality of step segments of different depths, each step segment defining a first surface substantially parallel to the first outer surface of the transparent substrate;
positioning a first reflector on the first surface of each step in the cavity; and
positioning a second, planar reflector on the first outer surface of the transparent substrate.

13. The method of claim 12 further comprising:
positioning an electromagnetic radiation detector aligned with each step segment in the cavity, each detector having a detector surface substantially parallel to the first surface of the corresponding step segment.

14. The method of claim 13 wherein the positioning the electromagnetic radiation detectors comprises bonding an integrated circuit containing the detectors to a second outer surface of the transparent substrate, the second outer surface of the transparent surface being substantially opposed to the first outer surface.

15. The method of claim 12 wherein the forming a cavity comprises etching the cavity to a plurality of different depths in different locations.

16. The method of claim 12 wherein the positioning the first reflector comprises depositing a reflective coating over the substrate using a chemical deposition process.

17. The method of claim 16 wherein the first reflector comprises a layer of silver.

18. The method of claim 12 wherein the first reflector comprises a plurality of Bragg reflectors.

19. The method of claim 12 further comprising;
filling the cavity with a transparent fill material after the positioning of the first reflector and prior to positioning the second, planar reflector.

20. The method of claim 19 further comprising:
planarizing the fill material.

21. The method of claim 20 wherein the positioning the second, planar reflector comprises depositing the second, planar reflector over the first outer surface and the fill material by a chemical deposition process.

22. A method of fabricating an array of spectroscopic cells comprising:
placing at least one first reflector on a first surface of a first, transparent substrate;
positioning a second, transparent substrate on the first surface of the first substrate over the at least one first reflector, the second, transparent substrate having different thicknesses in different portions thereof; and
placing at least one second reflector over the second, transparent substrate and at least one first reflector so as to provide a plurality of spaces of different depths between the at least one first reflector and the at least one second reflector in which electromagnetic radiation can bounce back and forth.

23. The method of claim 22 further comprising:
positioning a plurality of radiation detectors to receive electromagnetic radiation from one of the plurality the spaces of different depths passing through the at least one first reflector.

24. The method of claim 23 wherein the placing the plurality of radiation detectors comprises fabricating the plurality of radiation detectors in the first, transparent substrate.

25. The method of claim 23 wherein the positioning a plurality of radiation detectors comprises placing a plurality of radiation detectors on a second surface of the first, transparent substrate opposed to the first surface of the first, transparent substrate, each radiation detector disposed to receive electromagnetic radiation from one of the plurality the spaces of different depths passing through the at least one first reflector.

26. The method of claim 24 wherein:
the first substrate comprises a semiconductor on insulator substrate, the semiconductor on insulator substrate comprising an insulator layer and a semiconductor layer;
the positioning a plurality of radiation detectors comprises fabricating the plurality of radiation detectors on the insulator of the semiconductor on insulator substrate; and
the placing at least one first reflector on a first surface of a first, transparent substrate comprises positioning the first reflector on the radiation detector on the semiconductor on insulator substrate.

27. The method of claim 22 wherein the placing the plurality of radiation detectors comprises fabricating the plurality of radiation on a third substrate and disposing the third substrate adjacent the second surface of the first, transparent substrate.

28. A method of fabricating a spectroscope comprising:
fabricating a plurality of electromagnetic radiation detectors on an insulator layer of a semiconductor on insulator substrate, the semiconductor on insulator substrate comprising an insulator layer and a semiconductor layer;
positioning a first reflector on the electromagnetic radiation detector on the semiconductor on insulator substrate;
positioning a first transparent substrate on the first reflector opposite the electromagnetic radiation detector;
positioning a second, transparent substrate over the plurality of electromagnetic radiation detectors opposite the first reflector; and
placing at least one second reflector on the second, transparent substrate so as to provide a plurality of spaces of different depths between the at least one first reflector and the at least one second reflector, whereby electromagnetic radiation can bounce back and forth between the first reflector and the second reflector with one of the plurality of detectors in the space between the first reflector and the second reflector in each of the spaces of different depths.

29. The method of claim 28 wherein the removing of the semiconductor layer of the semiconductor on insulator substrate comprises etching using the insulator layer as an etch step.
